(19) United States
(12) Patent Application Publication
(10) Pub. No.: US 2026/0270148 A1
(43) Pub. Date: Sep. 10, 2026

(54) AVOID THE RE-PROVISIONING OF ALL UE POLICIES DURING AMF RELOCATION

(71) Applicant: Telefonaktiebolaget LM Ericsson (publ), Stockholm (SE)

(72) Inventors: Fuencisla Garcia Azorero, Madrid (ES); Susana Fernandez Alonso, Madrid (ES); Antonio Iniesta Gonzalez, Madrid (ES); Ignacio Rivas Molina, Madrid (ES); Maria Belen Pancorbo Marcos, Madrid (ES); Juying Gan, Shanghai (CN)

(21) Appl. No.: 19/099,841

(22) PCT Filed: Aug. 1, 2023
(86) PCT No.: PCT/EP2023/071275

§ 371 Date: Jan. 30, 2025

Related U.S. Application Data
(60) Provisional application No. 63/394,090, filed on Aug. 1, 2022.
(60) Provisional application No. 63/411,353, filed on Sep. 29, 2022.

(51) Int. Cl. H04L 41/0894; H04W 8/20; H04W 60/04; H04W 84/04

(52) U.S. Cl. CPC H04L 41/0894; H04W 8/20; H04W 60/04; H04W 84/042

(57) ABSTRACT

Disclosed herein is a method performed by a PCF. The method comprises: receiving a first message from a first AMF, the first message comprising an indication of serving node change; sending a second message to a UDR, the second message comprising a request for subscription data and/or a list of UE Policy Section Identifiers, UPSIs, for a UE; receiving a third message from the UDR, the third message comprising the subscription data and/or the list of UPSIs for the UE; and determining one or more new or updated UE policies for the UE based on the received third message and a current UE policy section of the UE.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) Technical Specification (TS) 23.503, clause 4.2.2 specifies that the Fifth Generation Core (5GC) shall be able to provide User Equipment (UE) Policies (Access Network Discovery and Selection policies (ANDSP), UE Route Selection Policies (URSP), V2X Policy (V2XP) and ProSe Policy (ProSeP) from the Policy Control Function (PCF) to the UE.

3GPP TS 23.503, clause 6.1.2.2.2 specifies a procedure for the delivery of UE policies from the PCF to the UE. The PCF may be triggered to provide the UE policy information during ‘UE Policy Association Establishment’ and ‘UE Policy Association Modification’ procedures as defined in clause 4.16.11 and clause 4.16.12 of 3GPP TS 23.502 or during the detection of other external (e.g., Application Function (AF) request) or internal (time triggered) triggers. The PCF includes the UE policy information within a UE Policy container that contains one or more UE Policy Section(s). Each of the one or more UE Policy Section(s) is identified by a UE Policy Section Identifier (UPSI) and is included within the ‘MANAGE UE POLICY COMMAND.’ The MANAGE UE POLICY COMMAND is sent to the Access and Mobility Management Function (AMF) using the ‘Namf_Communication’ service, and the AMF transparently sent the received UE Policy Container to the UE using Downlink (DL) Non-Access Stratum (NAS) Transport messages.

The UE keeps the received UE policies internally in a storage. At Initial Registration or Registration to 5GS (when the UE moves from EPS to 5GS), the UE provides a UE Policy container containing the ‘UE STATE INDICATION’ message with a list of stored UPSIs. During UE mobility with AMF relocation, the UE does not provide the UE Policy container and the list of stored UPSIs is not indicated to the PCF.

During UE Policy Association Establishment, if the PCF receives a UE policy container with a ‘UE STATE INDICATION’ message including a list of UPSIs, the PCF uses the received list of UPSIs to determine whether any new UE Policy Section needs to be delivered to the UE or whether existing UE Policy Sections need to be updated or deleted. If the PCF does not receive the list of UPSIs, the PCF determines the UE does not have any stored UE Policy and delivers all the applicable UE policies to the UE.

3GPP TS 23.502, clause 5.2.5.6.1 specifies that, during AMF relocation, if the target AMF receives the PCF ID from the source AMF and the target AMF decides to contact with the PCF identified by the PCF Identification (ID) based on the local policies, the target AMF requests the update (‘Npcf_UEPolicyControl_Update’) of the UE Policy Association. Otherwise, at AMF relocation, the target AMF triggers the establishment of the UE Policy Association.

### SUMMARY

There currently exist certain challenge(s). During the AMF relocation, if the target AMF does not receive the PCF ID from the source AMF, or if the target AMF receives the PCF ID from the source AMF but the target AMF decides to select a new PCF, the target AMF invokes the ‘UE Policy Association Establishment’ procedure.

But, since the UE does not include a UE Policy container with the ‘UE STATE INDICATION’ message indicating a list of UE stored UPSI(s), the AMF cannot deliver such information (the ‘UE STATE INDICATION’ message indicating a list of UE stored UPSI(s)) to the PCF. The PCF interprets then that the ‘UE Policy Establishment’ request is for a UE that does not have any stored UE Policy, and re-provisions already provisioned UE Policies to the UE, which results in the consequent increase of signalling procedures and waste of the corresponding processing resources. In addition, the provisioning of all the applicable UE policies may create UE misconfigurations, because the PCF might be missing the deletion of the UE Policies stored in the UE that might stop to apply.

In roaming scenarios, the Visited PCF (V-PCF) does not receive from the UE the Access Network Discovery and Selection Policies (ANDSP) support indication. This implies that the V-PCF does not know whether ANDSP policies need to be delivered to the UE and may send them when it is not necessary.

Certain aspects of the present disclosure and their embodiments may provide solutions to the aforementioned or other challenges. When the target AMF decides, at AMF relocation, to select a new PCF instance, the AMF indicates, during the UE Policy Association Establishment procedure, an AMF relocation indication (e.g., serving node change).

When the PCF receives the ‘UE Policy Association Establishment’ including an AMF relocation indication, then the PCF considers that the UE Policies stored in Unified Data Repository (UDR) are the ones stored in the UE, i.e., the PCF behaves as if a UE Policy Container including a list of UPSIs stored in the UDR had been received during the UE Policy Association. Then, after that point, the PCF behaves as in legacy, i.e. gets other UE information received during initial registration, and the PCF determines whether new UE Policy Sections shall be provided to the UE and/or existing UE Policy Sections shall be modified/deleted.

To cover roaming scenarios, the AMF relocation indication (serving node change) is sent at intra-operator mobility and inter-operator mobility with roaming (new Visited Policy Control Function (V-PCF) selection) scenarios. The V-PCF then includes the AMF relocation indication in the query to the Home Policy Control Function (H-PCF) over the N24 interface. The H-PCF, in the reply to the V-PCF, includes the ANDSP support indication stored for this UE in the UDR, so that the V-PCF can determine the applicable ANDSP accordingly.

This solution provides a method to avoid the reprovisioning of all UE Policies in the UE in scenarios of AMF relocation where the new AMF selects a different PCF.

There are, proposed herein, various embodiments which address one or more of the issues disclosed herein. Certain embodiments may provide one or more of the following technical advantage(s). The present disclosure optimizes the delivery of UE Policies to the UE in the scenarios of AMF relocation and new PCF instance selection and avoids potential UE misconfigurations. The optimization provides savings of signaling and processing resources in the PCF, the AMF and the UE, and the consequent improvement in energy efficiency.

### BRIEF DESCRIPTION OF THE DRAWINGS

The accompanying drawings, which are incorporated herein and form part of the specification, illustrate various embodiments.

FIG. 1 illustrates one example of a cellular communications system 100 in which embodiments of the present disclosure may be implemented.

FIG. 2 illustrates a 5G network architecture using point-to-point reference point/interface between the NFs in the CP.

FIG. 3 illustrates a 5G network architecture using service-based interfaces between the NFs in the CP.

FIG. 4 illustrates a UE Policy Association Establishment procedure in a non-roaming scenario.

FIG. 5 illustrates a UE Policy Association Establishment procedure in a roaming scenario.

FIG. 6 illustrates a method and a corresponding system in accordance with some embodiments of the present disclosure.

FIG. 7 illustrates a method and a corresponding system in accordance with some embodiments of the present disclosure.

FIG. 8 is a schematic block diagram of a network node 800 according to some embodiments of the present disclosure.

FIG. 9 is a schematic block diagram that illustrates a virtualized embodiment of the network node 800 according to some embodiments of the present disclosure.

FIG. 10 is a schematic block diagram of the network node 800 according to some other embodiments of the present disclosure.

FIG. 11 is a schematic block diagram of a wireless communication device 1100 (e.g., a UE) according to some embodiments of the present disclosure.

FIG. 12 is a schematic block diagram of the wireless communication device 1100 according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

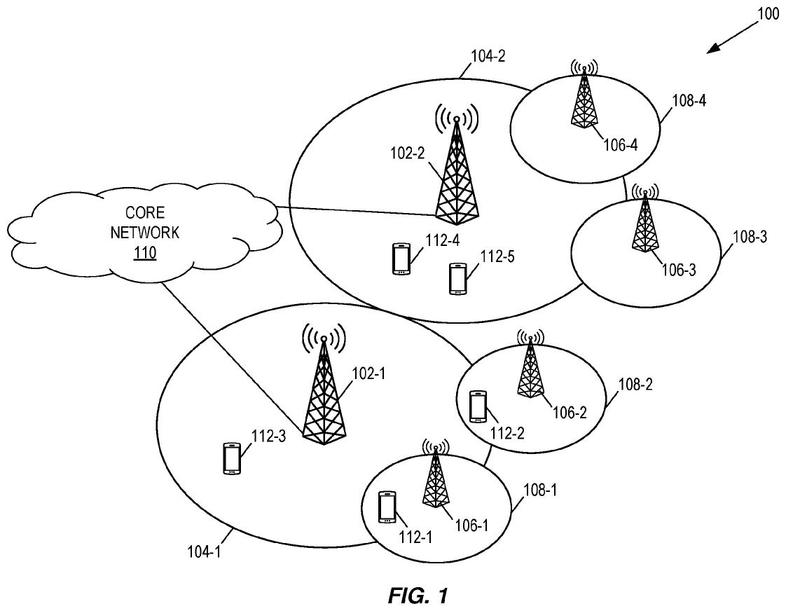

### FIG. 1

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 102-1 and 102-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

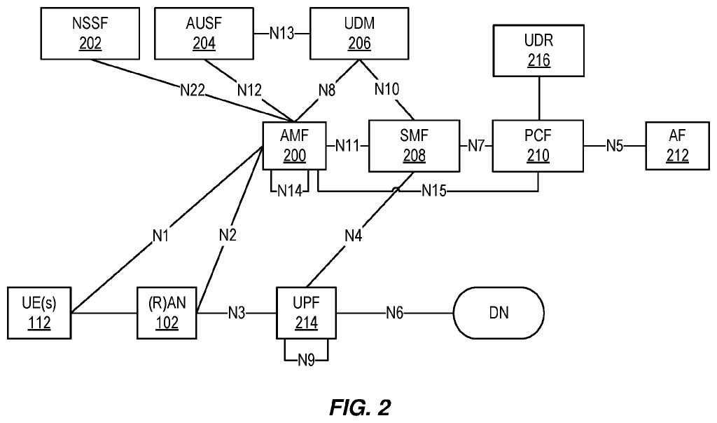

### FIG. 2

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212. The PCF 210 may be associated with or connected with a Unified Data Repository (UDR) 216. The UDR 216 may store network related data, such as subscription data, policy data, structured data for exposure, and application data.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating User Plane (UP) and Control Plane (CP). The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

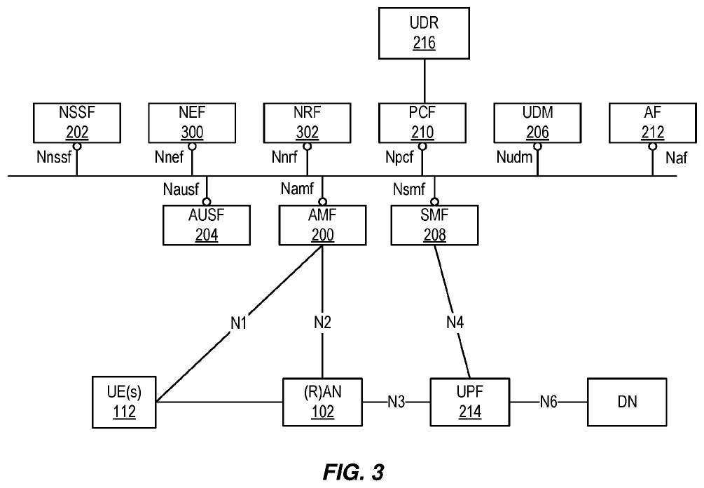

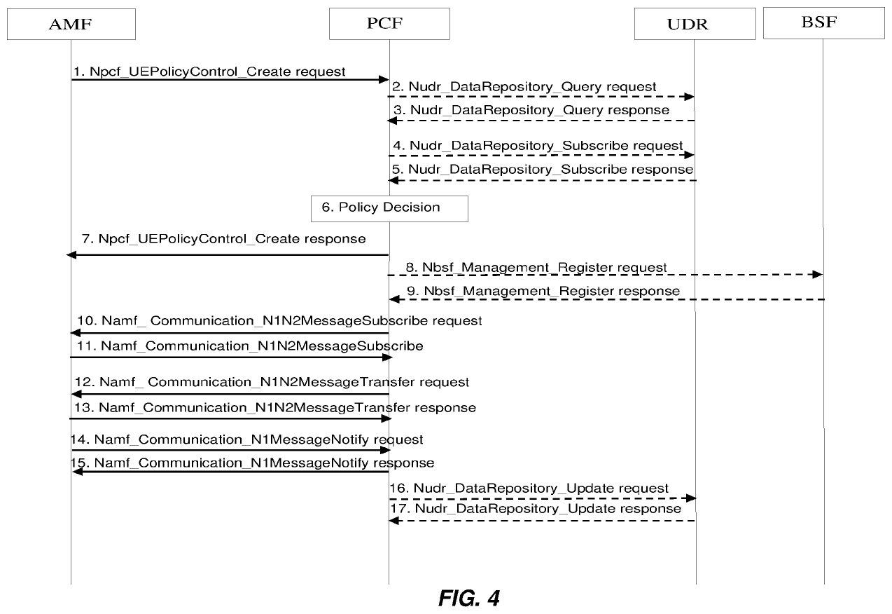

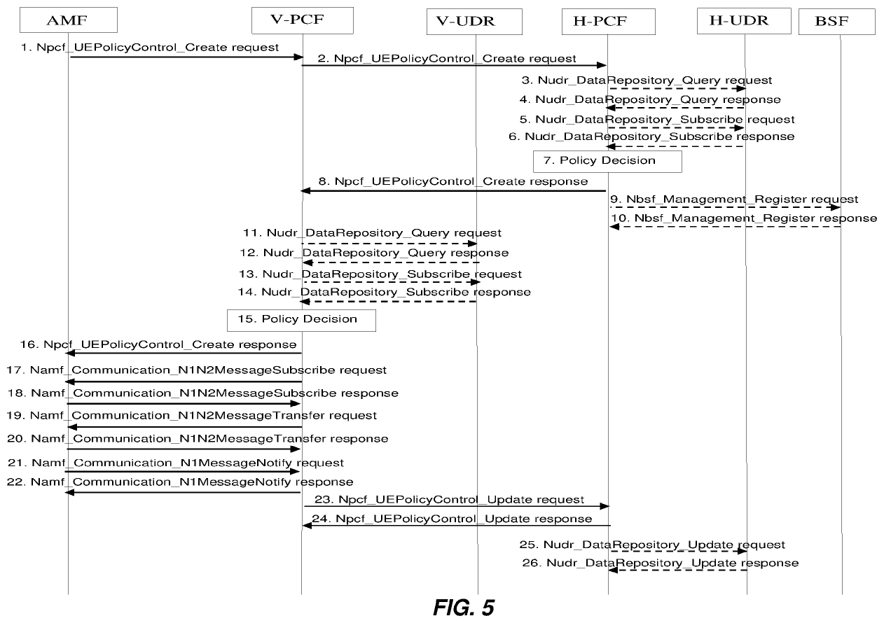

### FIG. 3

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

The detailed description of the present disclosure considers the current impacts in existing procedures under TS 29.513, clause 5.61. In this regard, a modified version of Clause 5.61 is provided below where additions are indicated via underlined, bold text marked as “NEW”.

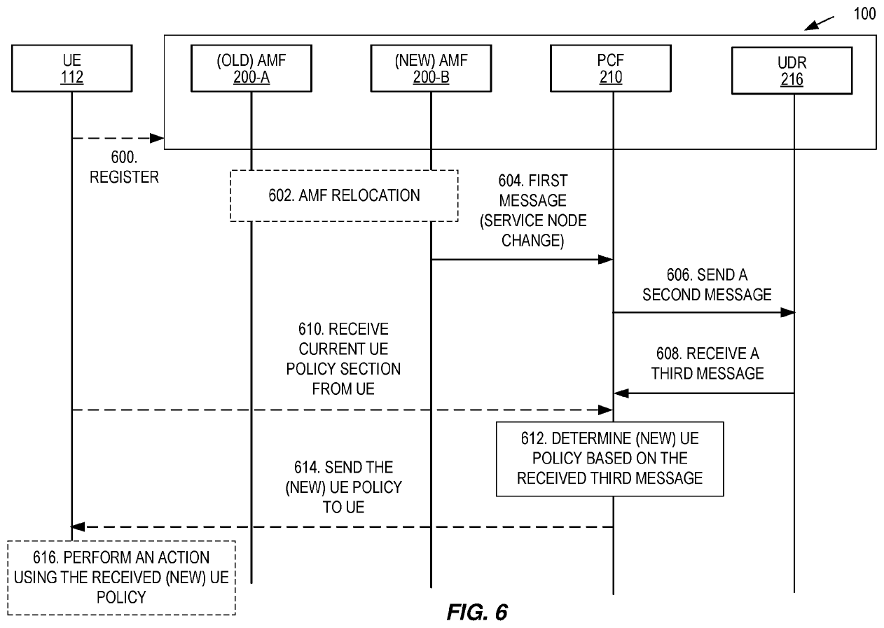

### FIG. 6

FIG. 6 illustrates a method and a corresponding system in accordance with some embodiments of the present disclosure.

In step 600, optionally, the UE 112 registers with the core network 100 that includes the AMFs 200 (the old AMF 200-A and the new AMF 200-B), the PCF 210, and the UDR 216.

In step 602, AMF relocation occurs. That is, the new AMF 200-B replaces the role of the old AMF 200-A and works for the registration procedure for the UE 112.

In step 604, the new AMF 200-B sends, to the PCF 210, a first message (e.g., a Npcf_UEPolicyControl_Create request). The first message includes an indication of serving node change that the new AMF 200-B includes during AMF relocation (in step 602).

In step 606, the PCF 210 sends a second message (e.g., Nudr_DataRepository_Query request) to the UDR 216. The second message includes a request for subscription data and/or a latest list of UPSIs for the UE 112.

In step 608, the PCF 210 receives a third message (e.g., Nudr_DataRepository_Query response) from the UDR 216. The third message includes the subscription data and/or the latest list of UPSIs for the UE 112.

In step 610, optionally, the PCF 210 receives a current UE policy section from the UE 112. Alternatively, the PCF 210 may already store or know the current UE policy section stored in the UE 112.

In step 612, the PCF 210 determines a new UE policy based on the subscription data and/or the latest list of UPSIs for the UE 112 and, optionally, based on the current UE policy section received from the UE 112. In one embodiment, in response to the PCF 210 receiving from the AMF 200-B the indication of serving node change, the PCF 210 considers that the UE Policy Section(s) stored in the UDR 216 (and received by the PCF 210 in step 608) match the UE Policy Section(s) stored in the UE 112 and calculates, based on subscription information and operator policies (e.g., received from UDR 216 in step 608), whether any new UE Policy needs to be installed in the UE 112 or whether existing UE Policies need to be updated/deleted. In addition, in response to the PCF 210 receiving the indication of serving node change from the AMF 200-B, the PCF 210 gets the value of ANDSP support indication, PEI, and OSId from the UDR 216 for that UE 112 if available (e.g., in steps 606 and 608) and will use them as the current values supported by the UE 112 for the determination of UE Policies in step 612.

In step 614, optionally, the PCF 210 sends the new UE policy(ies) to the UE 112, for example, via the new AMF 200-B.

In step 616, optionally, the UE 112 performs an action using the received new UE policy. For example, the UE 112 installs the received new UE policy along with the current UE policy section in its memory. Alternatively, the UE 112 updates the current UE policy section with the received new UE policy. Alternatively, the UE 112 deletes the current UE policy section and installs the received new UE policy.

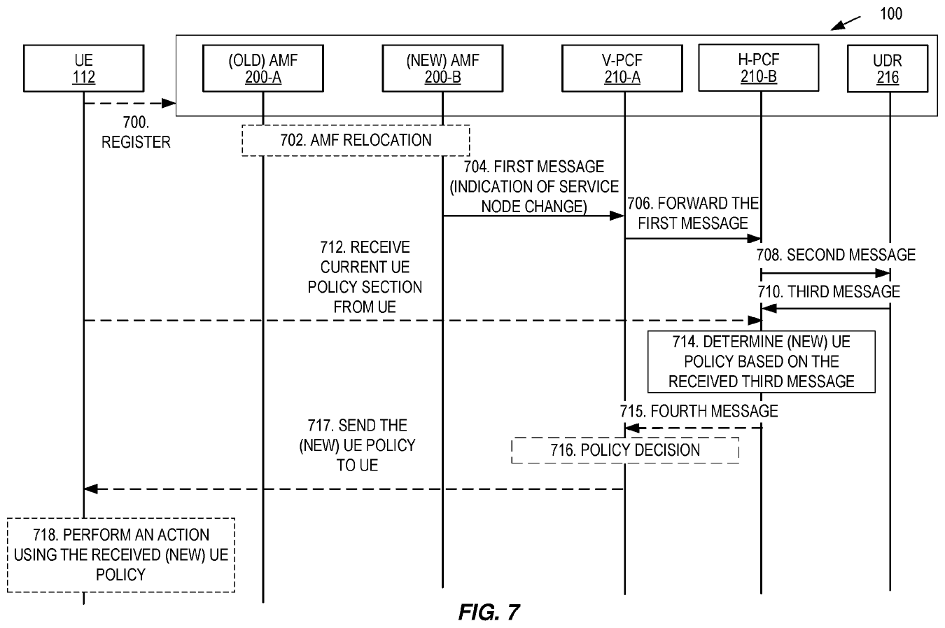

### FIG. 7

FIG. 7 illustrates a method and a corresponding system in accordance with some embodiments of the present disclosure.

In step 700, optionally, the UE 112 registers with the core network 100 that includes the AMFs 200 (the old AMF 200-A and the new AMF 200-B), the PCFs 210 (the V-PCF 210-A and the H-PCF 210-B), and the UDR 216.

In step 702, AMF relocation occurs. That is, the new AMF 200-B replaces the role of the old AMF 200-A and works for the registration procedure for the UE 112.

In step 704, the V-PCF 210-A receives, from the new AMF 200-B, a first message (e.g., Npcf_UEPolicyControl_Create request) that includes an indication of serving node change that the new AMF 200-B includes during AMF relocation (in step 702).

In step 706, the V-PCF 210-A forwards the first message to the H-PCF 210-B. Since the V-PCF 210-A received the indication of serving node change, the V-PCF 210-A forwards to the H-PCF 210-B the indication of serving node change (e.g., in the first message).

In step 708, the H-PCF 210-B sends a second message (e.g., Nudr_DataRepository_Query request) to the UDR 216.

The second message includes a request for subscription data and/or a latest list of UPSIs for the UE 112.

In step 710, the H-PCF 210-B receives a third message (e.g., Nudr_DataRepository_Query response) from the UDR 216.

The third message includes the subscription data and/or the latest list of UPSIs for the UE 112.

In step 712, optionally, the H-PCF 210-B receives a current UE policy section from the UE 112. Alternatively, the PCF 210 may already store or know the current UE policy section stored in the UE 112.

In step 714, the H-PCF 210-B determines a new UE policy based on the subscription data and/or the latest list of UPSIs for the UE 112 and, optionally, based on the current UE policy section received from the UE 112. Since the H-PCF 210-B received from the V-PCF 210-A the indication of serving node change, the H-PCF 210-B considers that the UE Policy Section(s) stored in the UDR 216 match the UE Policy Section(s) stored in the UE 112 and calculates, based on subscription information and operator policies (e.g., received in step 710), whether any new UE Policy needs to be installed in the UE 112 or whether existing UE Policies need to be updated/deleted.

In step 715, the H-PCF 210-B sends a response (e.g., a Npcf_UEPolicyControl_Create response) to the V-PCF 210-A. Since the H-PCF 210-B received the indication of serving node change, the H-PCF 210-B also includes the ANDSP support indication stored in the UDR 216 (received by the H-PCF 210-B, e.g., in step 710) for this UE 112 when sending the response to the V-PCF 210A.

In response to the V-PCF 210-A receiving the indication of serving node change from the AMF 200-B and receiving the ANDSP support indication for this UE 112 from the H-PCF 210-B, the V-PCF 210-B calculates, based on the received ANDSP support indication, the UE PLMN information and operator policies, whether ANDSP needs to be provided to the UE 112.

In step 716, the V-PCF 210-A determines whether and which UE policy has to be provisioned or updated.

In step 717, optionally, the V-PCF 210-A sends the new UE policy to the UE 112, for example, via the new AMF 200-B. This may include the ANDSP if the V-PCF 210-A determined that the ANDSP needs to be provided to the UE 112.

In step 718, optionally, the UE 112 performs an action using the received new UE policy. For example, the UE 112 installs the received new UE policy along with the current UE policy section in its memory. Alternatively, the UE 112 updates the current UE policy section with the received new UE policy. Alternatively, the UE 112 deletes the current UE policy section and installs the received new UE policy.

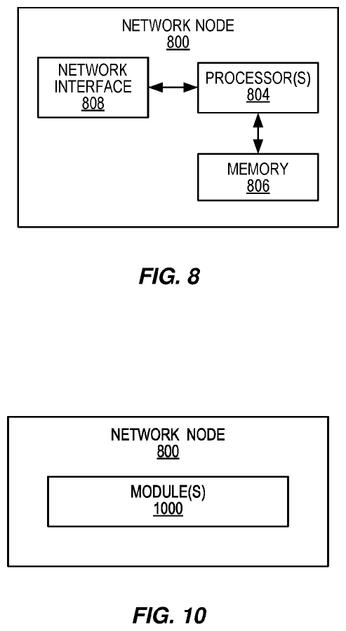

### FIG. 8

FIG. 8 is a schematic block diagram of a network node 800 according to some embodiments of the present disclosure. Optional features are represented by dashed boxes. The network node 800 may be, for example, a network node that implements all or part of the functionality of any of the core network functions (e.g., AMF, PCF, UDR, V-PCF, V-UDR, H-PCF, or H-UDR) described herein. As illustrated, the node 800 includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. The one or more processors 804 operate to provide one or more functions of the network node 800 (e.g., one or more functions of a (e.g., AMF, PCF, UDR, V-PCF, V-UDR, H-PCF, or H-UDR) as described herein. In some embodiments, the function(s) are implemented in software that is stored, e.g., in the memory 806 and executed by the one or more processors 804.

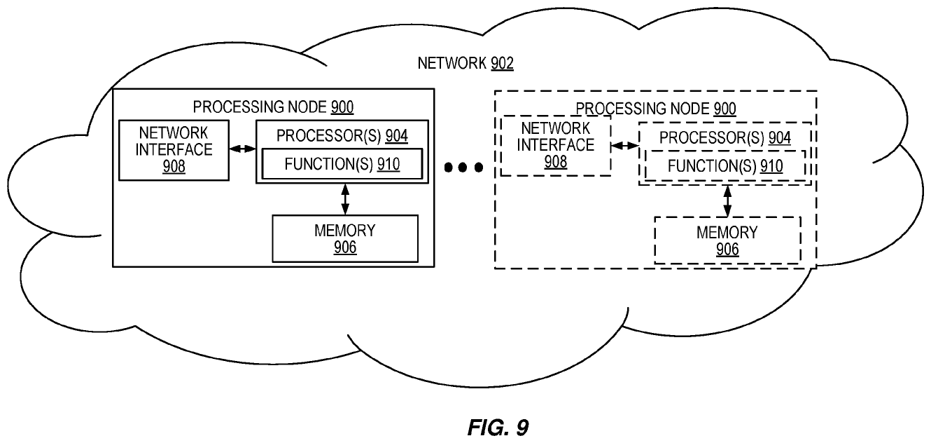

### FIG. 9

FIG. 9 is a schematic block diagram that illustrates a virtualized embodiment of the network node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 800 in which at least a portion of the functionality of the network node 800 is implemented as a virtual component(s) (e.g., via a virtual machine(s) executing on a physical processing node(s) in a network(s)). The network node 800 includes one or more processing nodes 900 coupled to or included as part of a network(s) 902. Each processing node 900 includes one or more processors 904 (e.g., CPUs, ASICs, FPGAs, and/or the like), memory 906, and a network interface 908.

In this example, functions 910 of the network node 800 described herein (e.g., one or more functions of a (e.g., AMF, PCF, UDR, V-PCF, V-UDR, H-PCF, or H-UDR described herein) are implemented at the one or more processing nodes 900 or distributed across the one or more processing nodes 900 in any desired manner. In some particular embodiments, some or all of the functions 910 of the network node 800 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 800 or a node (e.g., a processing node 900) implementing one or more of the functions 910 of the network node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 10

FIG. 10 is a schematic block diagram of the network node 800 according to some other embodiments of the present disclosure. The network node 800 includes one or more modules 1000, each of which is implemented in software. The module(s) 1000 provide the functionality of the network node 800 described herein. This discussion is equally applicable to the processing node 900 of FIG. 9 where the modules 1000 may be implemented at one of the processing nodes 900 or distributed across multiple processing nodes 900.

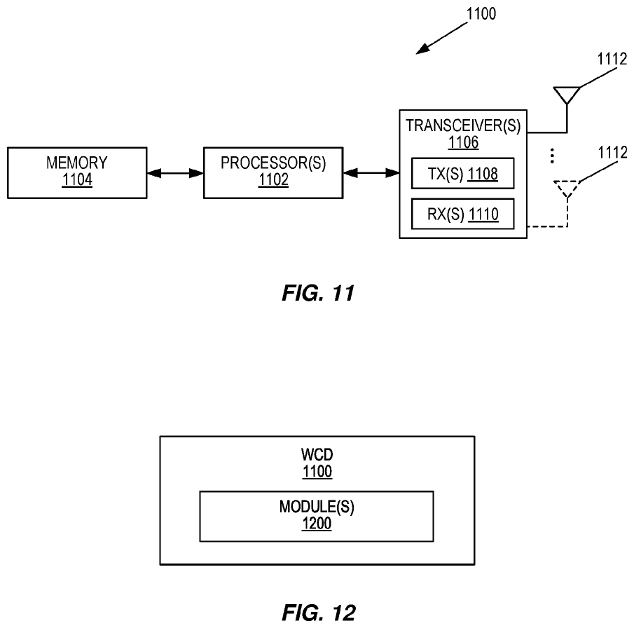

### FIG. 11

FIG. 11 is a schematic block diagram of a wireless communication device 1100 (e.g., a UE) according to some embodiments of the present disclosure. As illustrated, the wireless communication device 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 12

FIG. 12 is a schematic block diagram of the wireless communication device 1100 according to some other embodiments of the present disclosure. The wireless communication device 1100 includes one or more modules 1200, each of which is implemented in software. The module(s) 1200 provide the functionality of the wireless communication device 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### SUMMARY OF VARIOUS EMBODIMENTS

Some of the embodiments as described above may be summarized in the following manner:
1. A method performed by a Policy Control Function, PCF, (210), the method comprising:
   receiving (step 604) a first message from a first Access and Mobility Management Function, AMF (200-B), the first message comprising an indication of serving node change;
   sending (step 606) a second message to a Unified Data Repository, UDR, (216), the second message comprising a request for subscription data and/or a list of UE Policy Section Identifiers, UPSIs, for a User Equipment, UE, (112);
   receiving (step 608) a third message from the UDR (216), the third message comprising the subscription data and/or the list of UPSIs for the UE 112; and
   determining (step 612) one or more new or updated UE policies for the UE (112) based on the received third message and a current UE policy section of the UE (112).
2. The method of embodiment 1, further comprising receiving (step 610), from the UE (112), the current UE policy section of the UE (112).
3. The method of embodiment 1 or 2, further comprising sending (614) the new UE policy to the UE (112) via the first AMF (200-B).
4. The method of any of embodiments 1 to 3, wherein the first AMF (200-B) takes over functions of a second AMF (200-A) at AMF relocation (step 602).
5. The method of any of embodiments 1 to 4 wherein determining (612) the one or more new or updated UE policies for the UE (112) comprises determining (612) whether and which UE policy needs to be provisioned or updated for the UE (112).
6. The method of any of embodiments 1 to 5 wherein determining (612) the one or more new or updated UE policies for the UE (112) comprises, responsive to the indication of serving node change, determining (612) the one or more new or updated UE policies for the UE (112) considering that a UE policy section(s) received from the UDR (216) for the UE (112) (e.g., in the third message) match the current UE policy section(s) stored in the UE (112).
7. The method of any of embodiments 1 to 6 further comprising obtaining an ANSP support indication, PEI, and OSId from the UDR for the UE and using the obtained ANSP support indication, PEI, and OSId as current values supported by the UE for determining (612) the one or more new or updated UE policies for the UE (112).
8. The method of any of embodiments 1 to 7 further comprising sending (614) the one or more new or updated UE policies towards the UE (112).
9. A method performed by a Home Policy Control Function, H-PCF, (210-B), the method comprising:
   receiving (step 706) a first message from a Visited PCF, V-PCF, (210-A), the first message being sent (step 704) from a first Access and Mobility Management Function, AMF (200-B) to the V-PCF (210-A) and the first message comprising an indication of serving node change;
   sending (step 708) a second message to a Unified Data Repository, UDR, (216), the second message comprising a request for subscription data and/or a list of UE Policy Section Identifiers, UPSIs, for a User Equipment, UE, (112);
   receiving (step 710) a third message from the UDR (216), the third message comprising the subscription data and/or the list of UPSIs for the UE (112); and
   determining (step 714) one or more new or updated UE policies for the UE (112) based on the received third message and a current UE policy section of the UE (112).
10. The method of embodiment 9 wherein determining (714) the one or more new or updated UE policies for the UE (112) comprises determining (612) whether and which UE policy needs to be provisioned or updated for the UE (112).
11. The method of embodiment 9 or 10 wherein determining (714) the one or more new or updated UE policies for the UE (112) comprises, responsive to the indication of serving node change, determining (714) the one or more new or updated UE policies for the UE (112) considering that a UE policy section(s) received from the UDR (216) for the UE (112) (e.g., in the third message) match the current UE policy section(s) stored in the UE (112).
12. The method of any of embodiments 9 to 11 further comprising sending (715) a fourth message to the V-PCF (210-A), the fourth message comprising the one or more new or updated UE policies for the UE (112).
13. The method of embodiment 12 wherein the fourth message further comprises an ANDSP support indication received, by the H-PCF (210-B), from the UDR (216) (e.g., in the third message).
14. The method of any of embodiments 9 to 13, wherein the first AMF (200-B) takes over functions of a second AMF (200-A) at AMF relocation (step 702).
15. A network node adapted to perform the method of any of embodiments 1 to 14.
16. A method performed by a User Equipment, UE, (112), the method comprising:
   registering (600; 700) with a core network (100);
   receiving (614; 716) a new UE policy from a Policy Control Function, PCF, (210); and
   performing (616; 718) an action using the received new UE policy.
17. The method of embodiment 16, further comprising sending (614; 712) a current UE policy section to the PCF (210).
18. The method of embodiment 17, performing (616; 718) the action comprising installing the new policy along with the current policy section in a memory of the UE (112).
19. The method of embodiment 17, performing (616; 718) the action comprising updating the current policy section with the received new UE policy.
20. The method of embodiment 17, performing (616; 718) the action comprising deleting the current UE policy section and installing the received new UE policy in a memory of the UE (112).
21. A UE adapted to perform the method of any of embodiments 16 to 20.

1-21. (canceled)

22. A method performed by a Policy Control Function, PCF, the method comprising:
receiving a first message from a first Access and Mobility Management Function, AMF, the first message comprising an indication of serving node change;
sending a second message to a Unified Data Repository, UDR, the second message comprising a request for subscription data and/or a list of UE Policy Section Identifiers, UPSIs, for a User Equipment, UE;
receiving a third message from the UDR, the third message comprising UE Policy Section(s) stored in the UDR for the UE, and also the subscription data and/or the list of UPSIs for the UE;
receiving, from the UE, the current UE policy section stored in the UE;
determining, based on the subscription data and/or the list of UPSIs in the received third message, one or more new or updated UE policies for the UE considering that a UE policy section(s) received from the UDR for the UE match the current UE policy section(s) stored in the UE; and
sending the one or more new or updated UE policies to the UE via the first AMF.

23. The method of claim 22, wherein the first AMF takes over functions of a second AMF at AMF relocation.

24. The method of claim 22 wherein determining the one or more new or updated UE policies for the UE comprises determining whether and which UE policy needs to be provisioned or updated for the UE.

25. The method of claim 22 further comprising obtaining an ANSP support indication, PEI, and OSId from the UDR for the UE and using the obtained ANSP support indication, PEI, and OSId as current UE policy section for determining the one or more new or updated UE policies for the UE.

26. The method of claim 22 further comprising sending the one or more new or updated UE policies towards the UE.
